(19) United States
(12) Patent Application Publication
(10) Pub. No.: US 2026/0179293 A1
(43) Pub. Date: Jun. 25, 2026

(54) VIDEO GENERATION MODEL WITH DYNAMICS ADAPTERS

(71) Applicant: Lemon Inc., Grand Cayman (KY)

(72) Inventors: Di Chang, Los Angeles, CA (US); Hongyi Xu, Los Angeles, CA (US); You Xie, Los Angeles, CA (US); Guoxian Song, Los Angeles, CA (US); Chenxu Zhang, Los Angeles, CA (US); Yichun Shi, Los Angeles, CA (US); Linjie Luo, Los Angeles, CA (US)

(21) Appl. No.: 18/990,381

(22) Filed: Dec. 20, 2024

(51) Int. Cl. G06T 13/00; G06T 7/73

(52) U.S. Cl. CPC G06T 13/00; G06T 7/74; G06T 2207/10016; G06T 2207/20081; G06T 2207/30201

(57) ABSTRACT

A computing system including one or more processing devices configured to receive a reference image and an input video. The one or more processing devices execute a video generation model to compute an output video based at least in part on the reference image and the input video. The video generation model includes a denoising diffusion model that includes self-attention layers. The video generation model further includes dynamics adapters that are respectively associated with the self-attention layers and are each configured to, for each of the input video frames of the input video, receive the reference image and the input video frame. Each of the dynamic adapters computes a self-attention guidance matrix based at least in part on the reference image and the input video frame and inputs the self-attention guidance matrix into the denoising diffusion model. The one or more processing devices output the output video for display.

### BACKGROUND

Machine-learning-based human video generation has recently garnered growing interest due to its numerous applications in digital arts, social media and virtual avatars. Some recent techniques have approached human image animation as a controlled image-to-video diffusion task. These methods typically employ a parallel UNet to incorporate reference appearances through mutual self-attention, while body motion cues are incorporated as spatial guidance. Temporal modules have also been introduced to the diffusion backbone and have been trained from large-scale videos to enhance consistency and dynamics in visual sequence generation.

Despite improvements in control precision and generation realism, the combined modules for human image animation often fall short in capturing intricate visual dynamics, leading to static backgrounds and rigid human motions. This shortcoming, rooted in both network design and training data distributions, ultimately compromises the lifelike quality of the generated videos.

### SUMMARY

According to one aspect of the present disclosure, a computing system is provided, including one or more processing devices configured to receive a reference image. The one or more processing devices are further configured to receive an input video including a plurality of input video frames. The one or more processing devices are further configured to execute a video generation model to compute an output video based at least in part on the reference image and the input video. The video generation model includes a first denoising diffusion model that includes a plurality of first self-attention layers. The video generation model further includes a plurality of dynamics adapters that are respectively associated with the first self-attention layers and are each configured to, for each of the input video frames of the input video, receive the reference image and the input video frame. Each of the dynamic adapters is further configured to compute a self-attention guidance matrix based at least in part on the reference image and the input video frame. Each of the dynamic adapters is further configured to input the self-attention guidance matrix into the first denoising diffusion model after the first self-attention layer associated with the dynamics adapter. The one or more processing devices are further configured to output the output video for display at a display device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to execute a video generation model, according to one example embodiment.

FIG. 2 schematically shows layers of a first denoising diffusion model included in the video generation model, according to the example of FIG. 1.

FIG. 3 schematically shows layers of a face control model and a pose control model included in the video generation model, according to the example of FIG. 1.

FIG. 4 schematically shows the computing system during training of the video generation model, according to the example of FIG. 1.

FIG. 5A schematically shows an IP-Adapter architecture, according to one conventional approach.

FIG. 5B schematically shows a ReferenceNet architecture, according to one conventional approach.

FIG. 5C schematically shows the architecture of the video generation model, according to the example of FIG. 1.

FIG. 6A schematically shows an example preprocessing pipeline at which the one or more processing devices are configured to preprocess a training reference image and a training input video frame using a face swapping model, according to the example of FIG. 4.

FIG. 6B schematically shows an example preprocessing pipeline at which the one or more processing devices are configured to preprocess a training input video frame using the pose detector model, according to the example of FIG. 4.

FIG. 7A shows a flowchart of a method for use with a computing system to generate a video with a dynamic background, according to the example of FIG. 1.

FIGS. 7B-7E show additional steps of the method of FIG. 7A that may be performed in some examples.

FIG. 8 shows a schematic view of an example computing environment in which the computing system of FIG. 1 may be instantiated.

### DETAILED DESCRIPTION

In order to address the above shortcomings of existing human video generation techniques, a diffusion-based human image animation pipeline is provided herein. A video generation model that implements this pipeline achieves accurate transfer of poses and facial expressions along with consistent and vivid human and background dynamics.

The loss of dynamic details in prior human video generators primarily arises from the strong appearance constraints on spatial attention imposed by the appearance reference modules. The appearance reference module, in such prior approaches, is typically provided as a trainable copy of a parallel UNet.

To address this loss of dynamic details, the video generation model includes a lightweight cross-frame attention module, referred to as a dynamics adapter, which seamlessly propagates the reference appearance context to the denoising process by feeding the denoised reference image to a diffusion model in parallel with noised sequences. The dynamics adapter is integrated with the diffusion backbone via a trainable copy of the query projector and a zero-initialized output projector. This approach to integrating the diffusion backbone and the dynamics adapter allows the dynamics adapter to maintain its spatial and temporal generation capabilities.

Unlike in standard image-to-video (I2V) settings in which subsequent frames are generated from a reference image, the video generation model provided herein maintains appearance consistency from varying poses, in coordination with pose control modules. Notably, beyond body pose control, the video generation model employs a local control module to capture identity-disentangled facial expressions, thereby enhancing realism with accurate expression transfer.

While prior human image animation models are primarily trained on human videos with static backgrounds, the dynamics adapter used in the video generation model enables learning of subtle human dynamics and fluid environmental effects, in addition to body and facial expression controls. These patterns are learned from a diverse mixture of human and scene videos. Trained on a curated dataset of 900 h of human dancing and natural scene videos, the video generation model is able to accurately transfer body poses and facial expressions while generating lifelike human and scene dynamics consistent with a reference image context. The evaluations discussed below show that the video generation model outperforms previous human image animation baselines both quantitatively and qualitatively.

Recent advancements in latent diffusion models have greatly advanced human image animation. Previous approaches have commonly employed a two-stage training paradigm: in the first stage, a pose-driven image model is trained on individual video frames paired with corresponding pose images; in the second stage, a temporal module is introduced to capture temporal dynamics, while the image generation model remains fixed. In some examples, these previous approaches have integrated ReferenceNet with a UNet architecture to extract appearance features from reference characters.

With advancements in video foundation models, some recent works have simplified the training process by directly fine-tuning a diffusion model, thereby replacing the two-stage training approach. However, previous fine-tuning-based methods do not capture dynamics-related semantic information from a reference image. Previous fine-tuning-based methods also do not provide vivid animation of physical details from a natural background and a human foreground.

Dynamics generation has become an area of interest in video generation. Dynamics generation focuses on generating realistic motion and temporal consistency. Generative adversarial network (GAN)-based methods have pioneered the decomposition of motion and content, allowing for increased temporal coherence. However, GANs often struggle with complex motion scenes, and artifacts may appear due to difficulties in modeling long-term dependencies. Later GAN-based methods introduced gradual increases in resolution, achieving more stable results in video synthesis.

Diffusion models have emerged as powerful alternatives for video generation with methods that incorporate temporal conditioning to achieve consistency across frames. For instance, temporal resolution may be applied to produce smooth, continuous animations in human-centered videos. Similarly, temporal modeling strategies may be used to enhance dynamic texture quality, and often surpass GAN-based approaches in long-term coherence and photorealism.

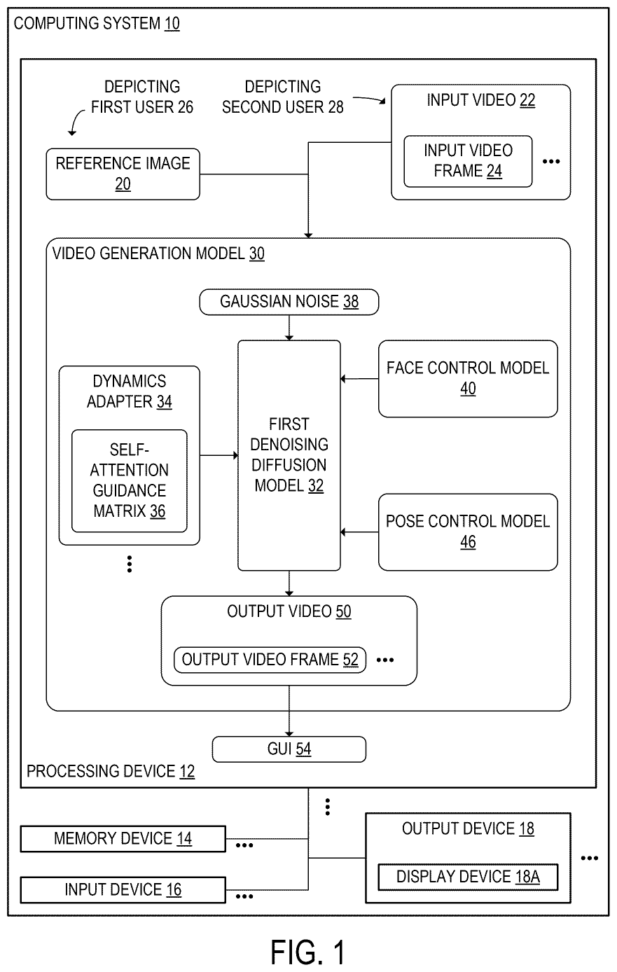

FIG. 1 schematically shows a computing system 10 at which a video generation model 30 is executed. The computing system 10 includes one or more processing devices 12 and one or more memory devices 14. The one or more processing devices 12 may, for example, include one or more central processing units (CPUs), graphics processing units (GPUs), tensor units, application-specific integrated circuits (ASICs), and/or other types of processing devices 12. The one or more memory devices 14 may include volatile memory and non-volatile storage. In some examples, the computing system 10 is distributed across a plurality of physical computing devices, whereas in other examples, the one or more processing devices 12 and the one or more memory devices 14 are included in a single physical computing device. In examples in which the computing system 10 is distributed across multiple physical computing devices, those physical computing devices may, for example, include one or more networked computing devices located at a data center.

The computing system 10 shown in FIG. 1 further includes one or more input devices 16 and one or more output devices 18. The one or more input devices 16 and output devices 18 enable user interaction with the computing system 10 and the computing processes executed thereupon. As shown in FIG. 1, the one or more output devices 18 include one or more display devices 18A. The one or more processing devices 12 are configured to present a graphical user interface (GUI) 54 that presents outputs to the user via the one or more display devices 18A. The GUI 54 is also configured to receive user input via the one or more input devices 16.

The one or more processing devices 12 are configured to receive a reference image 20. As shown in the example of FIG. 1, the reference image 20 may be an image depicting a first user 26. In addition, the one or more processing devices 12 are further configured to receive an input video 22 including a plurality of input video frames 24. The input video 22 may be a video depicting a second user 28.

The one or more processing devices 12 are further configured to execute a video generation model 30 to compute an output video 50 based at least in part on the reference image 20 and the input video 22. The output video 50 includes a plurality of output video frames 52. When the video generation model 30 generates the output video 50, the video generation model 30 maps the appearance of the reference image 20 onto the input video frames 24 of the input video 22. Accordingly, the one or more processing devices 12 are configured to generate an output video 50 in which the first user 26 depicted in the reference image 20 appears to take an action performed by the second user 28 in the input video 22.

Given a reference image 20 (also referred to below as I_{R}), the objective of the video generation model 30 is to animate the first user 26 depicted in that image with a pose and expression sequence Pᵢ derived from the input video 22, where i=1, . . . , T denotes the frame index. Some prior approaches have decomposed image guidance tasks into two main sub-tasks: (1) transferring the appearance of the individual and background from the reference image and (2) controlling the video frames based on the pose and expression sequence Pᵢ. However, these prior approaches do not typically produce realistic dynamic backgrounds. In contrast, the video generation model 30 not only focuses on generating temporally smooth image sequences but also provides lifelike background dynamics. These vivid and expressive dynamics for both the foreground human and the background scenes are generated in an end-to-end fashion, eliminating the need for foreground and background disentanglement pre- or post-processing steps.

The video generation model 30 includes a first denoising diffusion model 32. The denoising diffusion model 32 used in the example of FIG. 1 is a latent diffusion model that is initialized with Gaussian noise 38. Latent diffusion models are a class of diffusion models that synthesize samples in the image latent space, starting from Gaussian noise z_{T}˜ [symbol] (0,1) and refining the Gaussian noise through T denoising steps. During training, latent representations of images are progressively corrupted by Gaussian noise ϵ, following the Denoising Diffusion Probabilistic Model (DDPM) framework.

As discussed in further detail below, the denoising diffusion model 32 may be a UNet-based denoising backbone network that includes interleaved layers of convolutions and attentions, and that is trained to learn the reverse denoising process. The experiments discussed below use the pretrained text-to-image (T2I) diffusion model Stable Diffusion (SD) as the generative backbone.

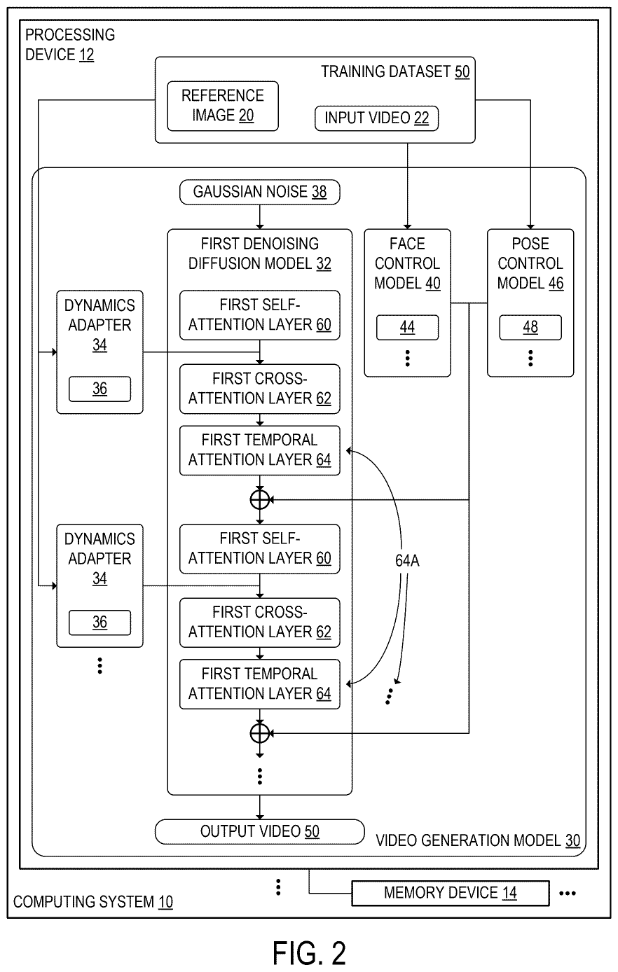

FIG. 2 schematically shows the layers of the first denoising diffusion model 32 in additional detail. The first denoising diffusion model 32 includes a plurality of first self-attention layers 60. The first denoising diffusion model 32 further includes a plurality of first cross-attention layers 62 and a plurality of first temporal attention layers 64. In the example of FIG. 2, the layers of the first denoising diffusion model 32 are arranged in a repeating pattern that includes a first self-attention layer 60 followed by a first cross-attention layer 62, followed by a first temporal attention layer 64. The plurality of first temporal attention layers collectively form a motion module 64A that is configured to increase the temporal smoothness of the output video 50.

Returning to FIG. 1, in addition to the denoising diffusion model 32, the video generation model 30 further includes a plurality of dynamics adapters 34, a face control model 40, and a pose control model 46. The video generation model 30 uses the dynamics adapters 34 to guide the first denoising diffusion model 32 toward generation of dynamic backgrounds. The dynamics adapters 34 are respectively associated with the first self-attention layers 60 of the denoising diffusion model 32. For each of the input video frames 24 of the input video 22, the dynamics adapters 34 are each configured to receive the reference image 20 and that input video frame 24. Each dynamics adapter 34 is further configured to compute a self-attention guidance matrix 36 based at least in part on the reference image 20 and the input video frame 24. In addition, as depicted in FIG. 2, each dynamics adapter 34 is further configured to input the self-attention guidance matrix 36 into the first denoising diffusion model 32 after the first self-attention layer 60 associated with the dynamics adapter 34.

The dynamics adapters 34 are configured to transfer user appearance and background context from the reference image 20 to the first denoising diffusion model 32 without compromising the dynamic motion synthesis capabilities of the first denoising diffusion model 32. The dynamics adapters 34 are accordingly configured to perform explicit cross-driven pose and expression control. In contrast to 12V tasks that do not use input videos, the task performed by the video generation model 30 accommodates motions that may differ significantly from the pose and expression of the reference image, often originating from subjects with distinct appearances. The dynamics adapters 34 are structured as a shared-weight, parallel UNet branch that injects layer-by-layer self-attention guidance of reference appearance features.

The self-attention computation in the transformer blocks of the first denoising diffusion model 32 can be represented as:

$${A}_{i} = softmax ( \frac{{Q}_{i} {K}_{i}^{T}}{\sqrt{d}} ) {V}_{i}$$

In the above equation, Qᵢ, Kᵢ, and Vᵢ are the query, key, and value matrices of the ith latent noise frame, respectively, and d is the dimension of the key and query matrices.

To introduce reference appearance guidance through the dynamics adapter 34, the prior capabilities of the original UNet are used to generate the key matrix K_{R} and the value matrix V_{R} from the denoised latent map of the reference image I_{R}. Additionally, a trainable copy of the query projector forms new query matrices Qᵢ′ from the latent noise of the generated frame Iᵢ. These new query matrices enable cross-frame attention to be computed as:

$${A}_{i}^{′} = softmax ( \frac{{Q}_{i}^{′} {K}_{R}^{T}}{\sqrt{d}} ) {V}_{R}$$

The one or more processing devices 12 are configured to input the self-attention guidance matrix 36 into the first denoising diffusion model 32 by computing a product of the self-attention matrix Aᵢ and a first output projection matrix W_{O} and adding the self-attention guidance matrix 36 to the product. The self-attention matrix Aᵢ is computed at the corresponding first self-attention layer 60. Thus, the two attention outputs discussed above are combined as follows to form an overall self-attention output:

$$O u {t}_{i} = ( {A}_{i} {W}_{o} ) + ( {A}_{i}^{′} {W}_{o}^{′} )$$

In the above equation, W_{O} and W_{O}′ are output projection matrices included in the dynamics adapter 34, and Aᵢ′W_{O}′ is the self-attention guidance matrix 36. The projection matrix W_{O}′ is modified during training of the dynamics adapters 34, as discussed below. The self-attention guidance matrix 36 enriches the original spatial attentions with correlated and detailed appearance information derived from the reference image 20.

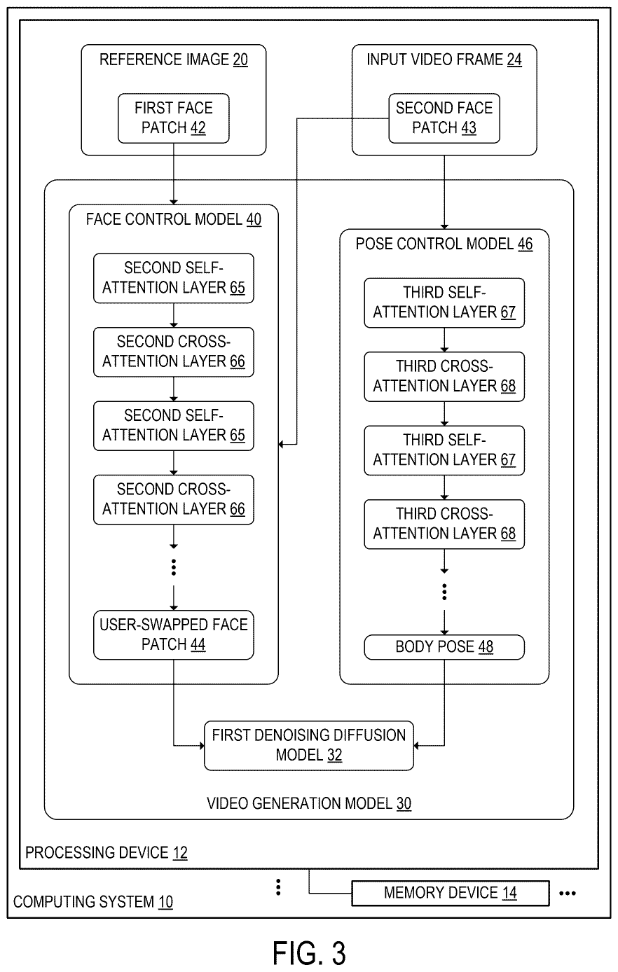

Turning now to FIG. 3, the face control model 40 and the pose control model 46 are discussed in additional detail. In human video synthesis, natural variations in facial expressions significantly enhance realism and expressiveness. While many human image animation models offer robust control over full body poses, there have been limited efforts in controlling both body poses and facial expressions. Previous approaches to representing head motion often use simplified face landmark maps that capture only key points such as the neck, nose, eyes, and ears. However, these simplified signals lack the detail needed for expressive facial animation. Moreover, even a basic facial skeleton encodes user-specific details such as face shapes, which may interfere with appearance transfer between users. The video generation model 30 discussed herein accordingly includes both a face control model 40 and a pose control model 46 in order to disentangle control over facial expressions and head poses.

The face control model 40 is configured to receive a first face patch 42 that is included in the reference image 20 and depicts a first user face of the first user 26. The one or more processing devices 12 may be configured to crop the reference image 20 to extract the first face patch 42. For each of the input video frames 24, the one or more processing devices 12 are further configured to compute a user-swapped face patch 44 that maps the first face patch 42 onto a corresponding second face patch 43 that is included in the input video frame 24 and depicts a second user face of the second user 28. The one or more processing devices 12 are further configured to input the user-swapped face patch 44 into the first denoising diffusion model 32. Accordingly, the first denoising diffusion model 32 is further configured to transfer the facial expression depicted in the reference image 20 onto the input video frames 24 during generation of the output video frames 52.

In the example of FIG. 3, the face control model 40 is a second denoising diffusion model that includes a plurality of second self-attention layers 65 and a plurality of second cross-attention layers 66. The second self-attention layers 65 alternate with the second cross-attention layers 66 in the example face control model 40 shown in FIG. 3.

As depicted in the example of FIG. 3, for each of the input video frames 24, the pose control model 46 is configured to receive that input video frame 24 and compute a respective body pose 48 of the second user 28 in the input video frame 24. The pose control model 46 is further configured to input the body pose 48 into the first denoising diffusion model 32. The denoising diffusion model 32 is further configured to match the appearance of the first user 26 depicted in the reference image 20 to the body pose 48 extracted from the input video frame 24 at the pose control model 46.

In the example of FIG. 3, the pose control model 46 is a third denoising diffusion model that includes a plurality of third self-attention layers 67 and a plurality of third cross-attention layers 68. The third self-attention layers 67 alternate with the third cross-attention layers 68 in the example pose control model 46 of FIG. 3.

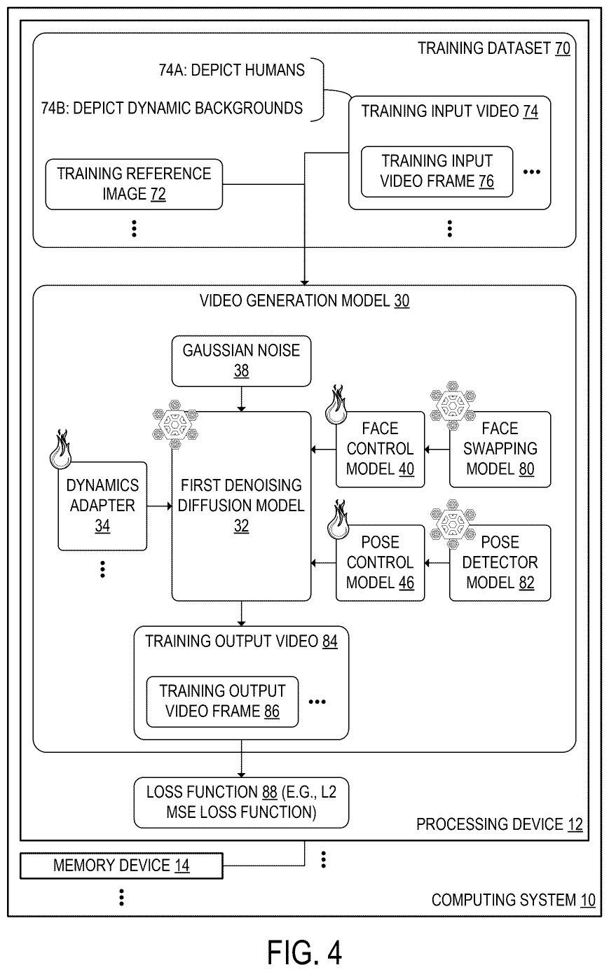

FIG. 4 schematically shows the computing system 10 during training of the video generation model 30. The dynamics adapters 34 are trained using a training dataset 70 including a plurality of training reference images 72. The training dataset 70 further includes a plurality of training input videos 74 that each include a plurality of training input video frames 76.

During training, the first denoising diffusion model 32 is configured to generate a plurality of training output videos 84 corresponding to the training reference images 72 paired with the training input videos 74. Each of the training output videos 84 includes a number of training output video frames 86 equal to the number of training input video frames 76 in the training input video 74 used to generate that training output video 84. The one or more processing devices 12 are further configured to evaluate the training output videos 84 according to a loss function 88 and perform gradient descent on the trainable parameters of the video generation model 30 according to a gradient of the loss function 88. In this example, the loss function 88 is an L2 mean squared error (MSE) loss function.

Prior human image animation models typically require static backgrounds in training videos. This requirement limits the capture of dynamic environmental details. On the other hand, collecting video data with both moving humans and dynamic backgrounds for training may be challenging. The one or more processing devices 12 therefore use a mixed data training strategy that allows the video generation model 30 to learn both human dynamics and background scene effects.

As shown in the example of FIG. 4, the plurality of training input videos 74 include a plurality of first training input videos 74A that depict humans and a plurality of second training input videos 74B that depict dynamic backgrounds and do not depict humans. Specifically, the training dataset 70 integrates natural scene videos, depicting scenes such as waterfalls, fireworks, and wind, with human motion videos. For videos without human subjects, the conditional inputs of the pose control model 46 and the face control model 40 are left blank, thereby enabling the video generation model 30 to generalize background motion independently. By using this mixed training dataset 70, the video generation model 30 achieves more realistic dynamic details than those trained solely on human videos. In addition, this training dataset 70 reduces unintended effects of ControlNets on background motion that would otherwise be produced by the blank regions occupied by humans in the training input videos.

During training, the weights of the first denoising diffusion model 32 are frozen, while the weights of the dynamic adapters 34, the face control model 40, and the pose control model 46 are trained. In addition, a face-swapping model 80 and a pose detector model 82 are used during training to pre-process the inputs to the face control model 40 and the pose control model 46, respectively. The face-swapping model 80 and the pose detector model 82 are pretrained models with weights that are kept frozen during training. In addition, the face swapping model 80 and the pose detector model 82 are omitted from the video generation model 30 during inferencing.

To implement the self-attention guidance matrix 36, the query projector weights W_{O} are initialized as those from the original UNet, and the output projection layer W_{O}′ is zero-initialized. This initialization preserves the preexisting behavior of the first denoising diffusion model 32. By leaving the generative diffusion backbone frozen during training, the one or more processing devices 12 are configured to disentangle appearance control from motion generation. This separation allows the diffusion backbone to focus exclusively on pose control and dynamics synthesis, while the dynamics adapters 34 manage appearance consistency across frames.

Previous research has introduced various strategies to maintain appearance consistency with a given reference image. Some approaches have represented reference appearance features using CLIP image embeddings, which are injected into text-conditioned cross-attention layers of the diffusion backbone. More recently, IP-Adapter incorporated image CLIP embeddings into the diffusion model via cross-attention layers, which learn to predict a residual over the original cross-attention latents. However, due to limitations in the ability of CLIP image embeddings to capture detailed appearance information, the approach used in IP-Adapter often results in noticeable inconsistencies in appearance transfer.

Other recent human image animation models have addressed the shortcomings of IP-Adapter by utilizing a ReferenceNet module for appearance control. ReferenceNet uses a parallel and trainable duplication of the entire diffusion UNet that is used as the diffusion backbone. ReferenceNet captures rich, detailed appearance features from a single reference image and interconnects with the self-attention layers of the diffusion UNet through feature concatenation. Although this method effectively transfers appearance features to the denoising process, the full set of trainable parameters in ReferenceNet often imposes a strong and strict influence over all spatial pixels, resulting in static backgrounds and rigid dynamics.

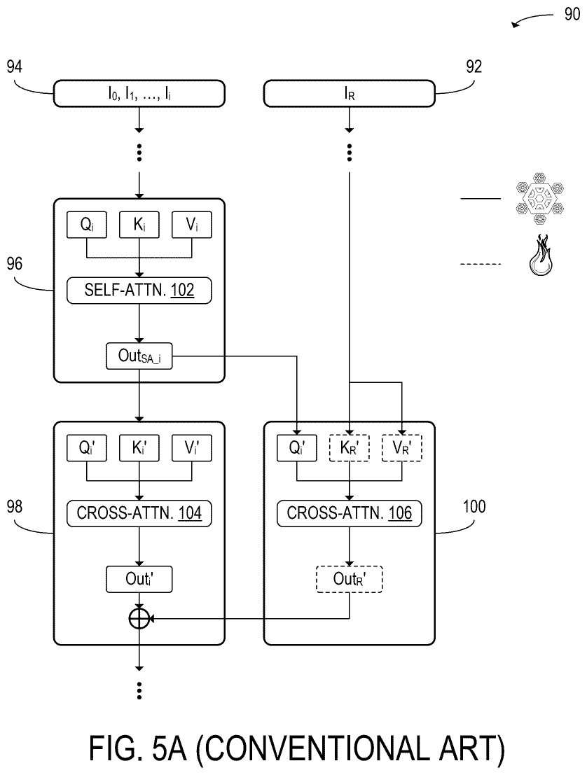

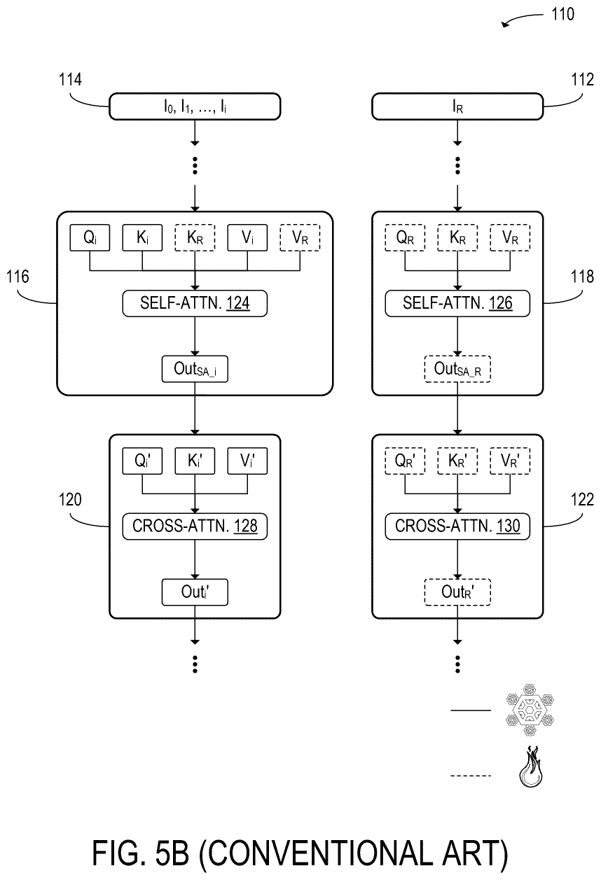

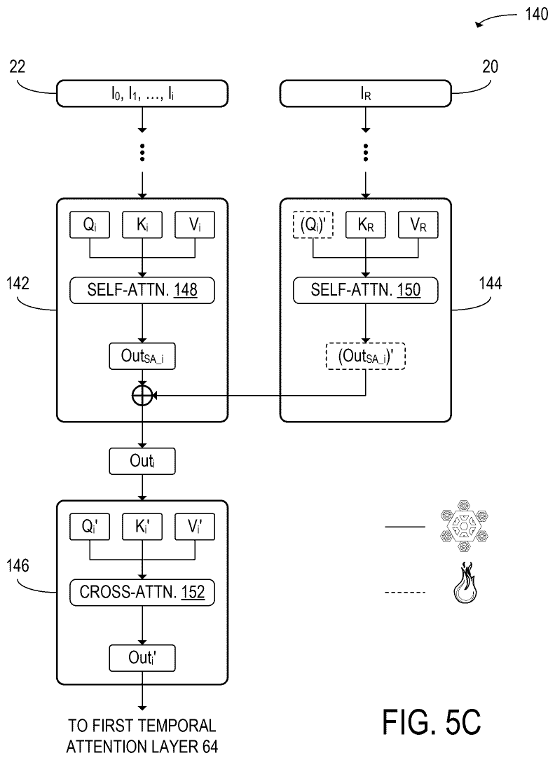

The dynamics adapters 34, as discussed above, address the above shortcomings of IP-Adapter in terms of appearance consistency and background dynamics. FIGS. 5A-5C schematically show respective architectures of IP-Adapter, ReferenceNet, and the video generation model 30. Trainable and frozen parameters of the layer architectures are also shown in FIGS. 5A-5C. The matrices labeled as trainable in the examples of FIGS. 5A-5C are computed using respective projection matrices that include, as matrix elements, respective parameters that are modified during training. In contrast, the projection matrices used to compute the matrices labeled as frozen are held constant during training.

FIG. 5A schematically shows an IP-Adapter architecture 90, according to one conventional approach. This IP-Adapter architecture 90 is configured to receive a reference image 92 and an input video 94. The IP-Adapter architecture 90 includes a self-attention block, a first cross-attention block 98, and a second cross-attention block 100. The second cross-attention block 100 is executed in parallel with the first cross-attention block 98. A temporal attention block, although not shown in the example of FIG. 5A, may also be included in the IP-Adapter architecture 90.

At the self-attention block 96, the one or more processing devices 12 are configured to compute a respective query matrix Qᵢ, key matrix Kᵢ, and value matrix Vᵢ. Based at least in part on the query matrix Qᵢ, the key matrix Kᵢ, and the value matrix Vᵢ, the one or more processing devices 12 are further configured to compute a self-attention 102, and to compute an output matrix Out_{SA_i} based at least in part on the self-attention 102.

At the first cross-attention block 98, the one or more processing devices 12 are further configured to compute a query matrix Qᵢ′, a key matrix Kᵢ′, and a value matrix Vᵢ′ based at least in part on the output matrix Out_{SA_i}. The one or more processing devices 12 are further configured to compute a cross-attention 104 based at least in part on the query matrix Qᵢ′, the key matrix Kᵢ′, and the value matrix Vᵢ′, and to compute a an output matrix Outᵢ′ based at least in part on the cross-attention 104.

At the second cross-attention block 100, the one or more processing devices 12 are further configured to receive a copy of the query matrix Qᵢ′. The one or more processing devices 12 are further configured to compute a key matrix K_{R}′ and a value matrix V_{R}′ based at least in part on the reference image 92. The one or more processing devices 12 are further configured to compute a cross-attention 106 based at least in part on the query matrix Qᵢ′, the key matrix K_{R}′, and the value matrix V_{R}′, and to compute an output matrix Outᵢ′ based at least in part on the cross-attention 106. The one or more processing devices 12 are further configured to concatenate the output matrices Outᵢ′ and Out_{R}′ to form an output of a cross-attention layer. That concatenated output may be transmitted to a temporal attention layer.

In the example of FIG. 5A, the key matrix K_{R}′, the value matrix V_{R}′, and the output matrix Outᵢ′ are trainable while the other matrices are frozen.

FIG. 5B schematically shows a ReferenceNet architecture 110, according to one conventional approach. The ReferenceNet architecture 110 is configured to receive a reference image 112 and an input video 114. The ReferenceNet architecture 110 includes a first self-attention block 116, a second self-attention block 118, a first cross-attention block 120, and a second cross-attention block 122. The first self-attention block 116 and the second self-attention block 118 may be executed in parallel as a self-attention layer, and the first cross-attention block 120 and the second cross-attention block 122 may be executed in parallel as a cross-attention layer. A temporal attention layer, although not shown in FIG. 5B, may also be included in the ReferenceNet architecture 110.

At the first self-attention block 116, the one or more processing devices 12 are configured to compute a query matrix Qᵢ, key matrices Kᵢ and K_{R}, and value matrices Vᵢ and V_{R}. The query matrix Qᵢ, the key matrix Kᵢ, and the value matrix Vᵢ are computed based at least in part on the input video 114, whereas the key matrix K_{R} and the value matrix V_{R} are computed based at least in part on the reference image. Based at least in part on the query matrix Qᵢ, the key matrices Kᵢ and K_{R}, and the value matrices Vᵢ and V_{R}, the one or more processing devices 12 are further configured to compute a self-attention 124 and to compute an output matrix Out_{SA_i} based at least in part on the self-attention 124.

At the second self-attention block 118, the one or more processing devices 12 are further configured to compute a query matrix Q_{R} and to receive respective copies of the key matrix K_{R} and the value matrix V_{R}. The query matrix Q_{R} is computed based at least in part on the reference image 112. Based at least in part on the query matrix Q_{R}, the key matrix K_{R}, and the value matrix V_{R}, the one or more processing devices 12 are further configured to compute a self-attention 126 and to compute an output matrix Out_{SA_R} based at least in part on that self-attention 126.

At the first cross-attention block 120, the one or more processing devices 12 are further configured to compute a query matrix Qᵢ′, a key matrix Kᵢ′, and a value matrix Vᵢ′ based at least in part on the output matrix Out_{SA_i}. The one or more processing devices 12 are further configured to compute a cross-attention 128 based at least in part on the query matrix Qᵢ′, the key matrix Kᵢ′, and the value matrix Vᵢ′, and to compute a an output matrix Outᵢ′ based at least in part on the cross-attention 128.

At the second cross-attention block 122, the one or more processing devices 12 are further configured to compute a query matrix Q_{R}′, a key matrix K_{R}′, and a value matrix V_{R}′ based at least in part on the output matrix Out_{SA_R}. The one or more processing devices 12 are further configured to compute a cross-attention 130 based at least in part on the query matrix Q_{R}′, the key matrix K_{R}′, and the value matrix V_{R}′, and to compute an output matrix Outᵢ′ based at least in part on the cross-attention 130.

In the ReferenceNet architecture 110, the query matrices Q_{R} and Q_{R}′, the key matrices K_{R} and K_{R}′, the value matrices V_{R} and V_{R}′, and the output matrices Out_{SA_R} and Out_{R}′ are trainable. The other matrices included in the ReferenceNet architecture 110 are frozen during training.

FIG. 5C schematically shows a video generation model architecture 140, including a first self-attention block 142, a second self-attention block 144, and a cross-attention block 146. The first temporal attention layer 64 is not shown in the example of FIG. 5C, nor are the face control model 40 and the pose control model 46. The first self-attention block 142 and the cross-attention block 136 are included in the first denoising diffusion model 32, and the second self-attention block 144 is included in the dynamics adapter 34.

At the first self-attention block 142, the one or more processing devices 12 are configured to compute a query matrix Qᵢ, a key matrix Kᵢ, and a value matrix Vᵢ. The one or more processing devices 12 are further configured to compute a self-attention 148 based at least in part on the query matrix Qᵢ, the key matrix Kᵢ, and the value matrix Vᵢ. The self-attention 148 may be computed using the equation for Aᵢ discussed above. In addition, the one or more processing devices 12 are configured to compute an output matrix Out_{SA_i} based at least in part on the self-attention 148.

At the second self-attention block 134, the one or more processing devices 12 are further configured to compute a query matrix (Qᵢ)′, a key matrix K_{R}, and a value matrix V_{R} based at least in part on the reference image 20. The one or more processing devices 12 are further configured to compute a self-attention matrix 150 based at least in part on the query matrix (Qᵢ)′, the key matrix K_{R}, and the value matrix V_{R}, and to compute an output matrix (Out_{SA_i})′ based at least in part on the self-attention 150. This output matrix (Out_{SA_i})′ is the self-attention guidance matrix 36 discussed above.

The one or more processing devices 12 are further configured to add the output matrices Out_{SA_i} and (Out_{SA_i})′ to obtain an overall self-attention output Outᵢ, as discussed above, and to transmit the overall self-attention output Outᵢ to the cross-attention block 146. At the cross-attention block 146, the one or more processing devices 12 are further configured to compute a query matrix Qᵢ′, a key matrix Kᵢ′, and a value matrix Vᵢ′ based at least in part on the sum, and to compute a cross-attention 152 based at least in part on the query matrix Qᵢ′, the key matrix Kᵢ′, and the value matrix Vᵢ′. The one or more processing devices 12 are further configured to compute an output matrix Outᵢ′ based at least in part on the cross-attention 152, and the transmit the output matrix Outᵢ′ to the first temporal attention layer 64.

In the video generation model architecture 140, as shown in the example of FIG. 5C, the query matrix (Qᵢ)′ and the output matrix (Outᵢ)′ are trainable while the other matrices are frozen during training. Thus, during training of the video generation model 30, at each of the dynamics adapters 34, respective parameters of the query matrix (Qᵢ)′ and the self-attention guidance matrix (Outᵢ)′ included in the dynamics adapter 34 are modified. Respective parameters of the key matrix K_{R} and the value matrix V_{R} included in the dynamics adapter 34 are held constant.

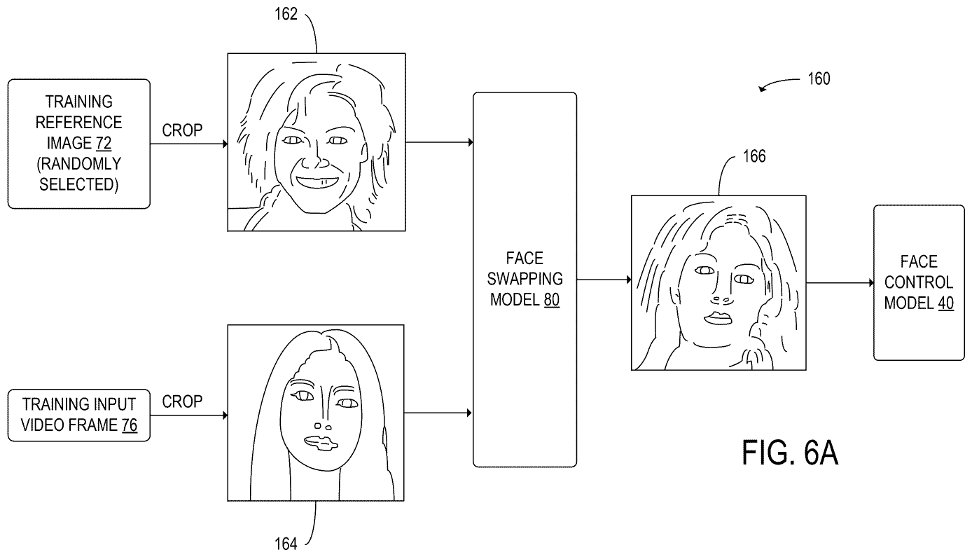

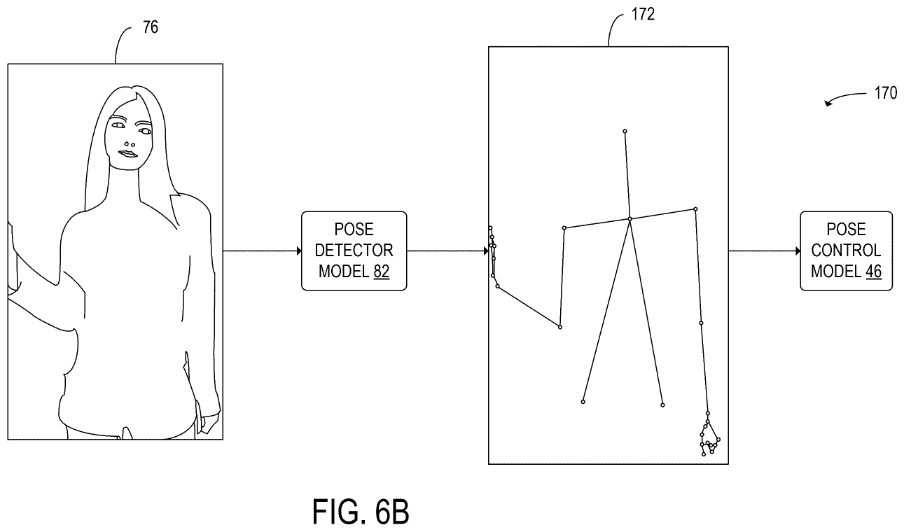

FIG. 6A schematically shows an example preprocessing pipeline 160 at which the one or more processing devices 12 are configured to preprocess a training reference image 72 and a training input video frame 76 using the face swapping model 80, according to the example of FIG. 4. Instead of using an explicit face landmark map computed from the training input video frame 76, the one or more processing devices 12 are instead configured to crop the training input video frame 76 to obtain a video frame face patch 164. The one or more processing devices 12 are further configured to select a random training reference image 72 and crop the training reference image 72 to obtain a reference image face patch 162. In some examples, the training reference image 72 is selected at random from among the plurality of training input video frames 76 of a training input video 74 that depicts a different user compared to the training input video frame 76.

The one or more processing devices 12 are further configured to process the reference image face patch 162 and the video frame face patch 164 at the face swapping model 80 to obtain a training user-swapped face patch 166. The face swapping model 80 is configured to transfer a facial expression of the reference image face patch 162 onto the video frame face patch 164. The face swapping model 80 is a pretrained portrait reenactment network. The one or more processing devices 12 are further configured to reinsert the training user-swapped face patch 166 at the original position of the training input video frame 76, with the other pixels of the training input video frame 76 masked as blank. The one or more processing devices 12 are further configured to input the reinserted training user-swapped face patch 166 into the face control model 40.

Unlike explicit motion control signals, the training approach of the face control model 40 allows the face control model 40 to learn user-disentangled facial expressions and head movements implicitly from the training input video frame 76. The remapping reduces appearance leakage from the input video 22. The preprocessing pipeline 160 of FIG. 6A bypasses the need for the face swapping model 80 during inferencing, thereby allowing expression control directly from the driving video.

FIG. 6B schematically shows an example preprocessing pipeline 170 that may be executed at the one or more processing devices 12 to preprocess a training input video frame 76 using the pose detector model 82. As shown in the example of FIG. 6B, the pose detector model 82 is configured to receive the training input video frame 76 and compute a pose skeleton 172 of the user depicted in the training input video frame 76. The pose detector model 82 is further configured to transmit the pose skeleton 172 to the pose control model 46. The pose detector model 82 is a pretrained model that is kept frozen during training of the video generation model 30.

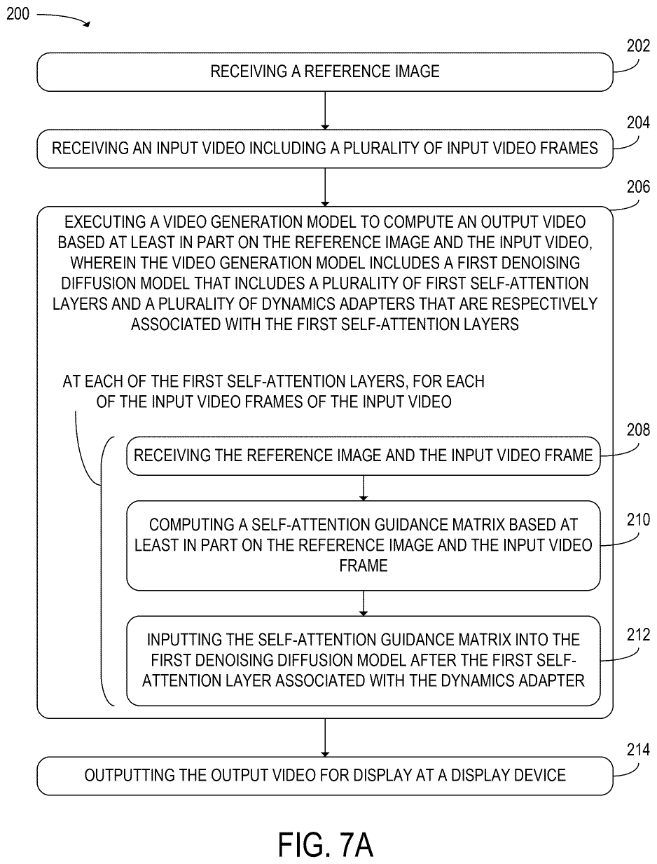

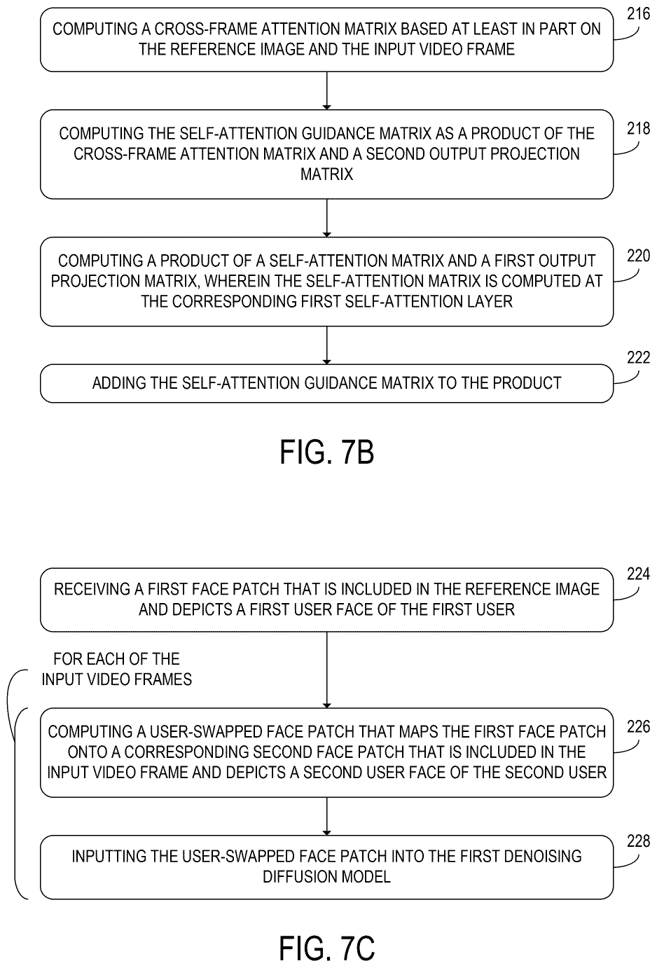

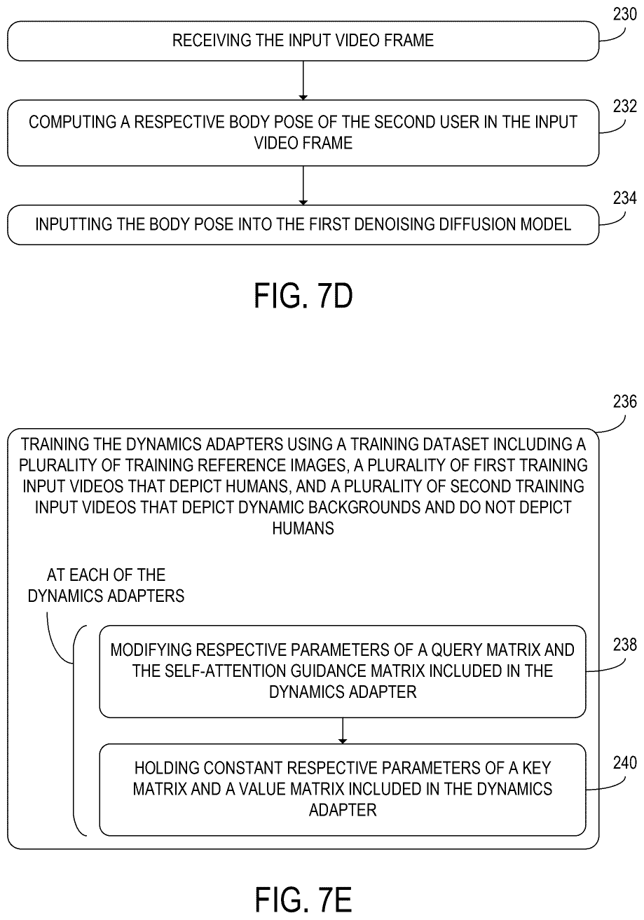

FIG. 7A shows a flowchart of a method 200 for use with a computing system to generate a video with a dynamic background. At step 202, the method 200 includes receiving a reference image. The reference image may be an image depicting a first user. At step 204, the method 200 further includes receiving an input video including a plurality of input video frames. The input video is a video depicting a second user.

At step 206, the method 200 further includes executing a video generation model to compute an output video based at least in part on the reference image and the input video. The input video may be a driving video that the video generation model uses to map an action performed by the second user onto the reference image that depicts the first user. The video generation model includes a first denoising diffusion model that includes a plurality of first self-attention layers. The first denoising diffusion model may be a pretrained model that is used as the diffusion backbone of the video generation model. In some examples, the first denoising diffusion model further includes a plurality of first cross-attention layers and a plurality of first temporal attention layers.

The video generation model further includes a plurality of dynamics adapters that are respectively associated with the first self-attention layers. For example, each of the dynamics adapters may be structured as a self-attention block. The dynamics adapters are configured to guide the first denoising diffusion model toward generating video that depicts a dynamic background.

Step 206 of the method 200 includes steps 208, 210, and 212, which are performed at each of the dynamics adapters for each of the input video frames of the input video. At step 208, the method 200 further includes receiving the reference image and the video frame at the dynamics adapter. At step 210, the method 200 further includes computing a self-attention guidance matrix based at least in part on the reference image and the input video frame. At step 212, the method 200 further includes inputting the self-attention guidance matrix into the first denoising diffusion model after the first self-attention layer associated with the dynamics adapter.

At step 214, the method 200 further includes outputting the output video for display at a display device. In some examples, performing step 214 may include transmitting the output video from a server computing device to a client computing device at which a GUI is displayed.

FIGS. 7B-7E show additional steps of the method 200 that may be performed in some examples. FIG. 7B shows additional steps that may be performed when computing the self-attention guidance matrix and inputting it into the first denoising diffusion model. The steps of FIG. 7B may be performed at each of the dynamics adapters. At step 216, the method 200 may further include computing a cross-frame attention matrix based at least in part on the reference image and the input video frame. At step 218, the method 200 may further include computing the self-attention guidance matrix as a product of the cross-frame attention matrix and a second output projection matrix.

At step 220, the method 200 may further include computing a product of a self-attention matrix and a first output projection matrix. In this example, the self-attention matrix is computed at the corresponding first self-attention layer. At step 222, the method 200 may further include adding the self-attention guidance matrix to the product. The self-attention guidance matrix is thereby input into the first denoising diffusion model. In some examples, a corresponding dynamics adapter may input a respective self-attention guidance matrix into each of the first self-attention layers included in the first denoising diffusion model.

FIG. 7C shows steps that may be performed in some examples at a face control model included in the video generation model. At step 224, the method 200 may further include receiving a first face patch that is included in the reference image and depicts a first user face of the first user. FIG. 7C further shows steps 226 and 228, which may be performed for each of the input video frames. At step 226, the method 200 may further include computing a user-swapped face patch that maps the first face patch onto a corresponding second face patch that is included in the input video frame and depicts a second user face of the second user. At step 228, the method 200 may further include inputting the user-swapped face patch into the first denoising diffusion model. For example, the user-swapped face patch may be concatenated with the outputs of the temporal attention layers included in the first denoising diffusion model.

FIG. 7D shows additional steps that may be performed in some examples for each of the input video frames at a pose control model included in the video generation model. At step 230, the method 200 may further include receiving the input video frame. At step 232, the method 200 may further include computing a respective body pose of the second user in the input video frame. At step 234, the method 200 may further include inputting the body pose into the first denoising diffusion model. Similarly to the user-swapped face patch in the example of FIG. 7C, the body pose may be concatenated with the outputs of the temporal layers of the first denoising diffusion model.

FIG. 7E shows steps that may be performed during training of the video generation model. At step 236, the method 200 may further include training the dynamics adapters using a training dataset including a plurality of training reference images. In addition, the training dataset may include a plurality of first training input videos that depict humans and a plurality of second training input videos that depict dynamic backgrounds and do not depict humans. By using a mixed training dataset of human and non-human training input videos, the dynamics adapter may be trained to steer the first denoising diffusion model toward depicting both human movement and dynamic backgrounds.

During training of the video generation model, training each of the dynamics adapters may include, at step 238, modifying respective parameters of a query matrix and the self-attention guidance matrix included in the dynamics adapter. In addition, at step 240, training each of the dynamics adapters may further include holding constant respective parameters of a key matrix and a value matrix included in the dynamics adapter. In some examples, the plurality of dynamics adapters included in the video generation model have shared parameters with each other.

Experimental results for the video generation model are provided below. In the experiments discussed below, the video generation model was trained using a training dataset including monocular camera recordings of 30-second human motions from 107,546 videos (900 hours in total) with both indoor and outdoor scenes. The training data was processed with a cropped resolution of 896×512. In addition, low-quality sequences were filtered out of the training dataset. The training input videos of humans depicted a diverse range of motions and expressions in various scenes. The training input videos that depicted dynamic backgrounds without human subjects were obtained from the Skyscape dataset, which includes 3000 time-lapse videos of dynamic sky scenes, e.g., cloudy skies and night scenes with moving stars.

In these experiments, Stable Diffusion (SD) 1.5 was utilized as the first denoising diffusion model. The weights of SD 1.5 were frozen during the entire training phase. Prior to training, the weights of the pose control model, the face control model, and the dynamics adapters were initialized as weights of SD 1.5. The weights of the motion module included in the first denoising diffusion model were initialized as the weights of AnimateDiff v1. In a first stage, the dynamics adapters, the pose control model, and the motion module were trained with a mixture of human-depicting and non-human-depicting training input videos for five epochs. In a second stage, the dynamics adapters the pose control model, and the motion module were frozen and the face control model was trained for two epochs using human-depicting training input videos only.

An AdamW optimizer with a learning rate of 10⁻⁵ was utilized to train all the modules of the video generation model. Each module underwent training with 16 videos in each step. During inferencing, the face-swapping model was not used. Instead, the cropped local face patches from the driving video were fed into the face control model.

The quantitative metrics peak signal-to-noise ratio (PSNR), structural similarity index measure (SSIM), L1 distance, perceptual similarity (LPIPS), Fréchet inception distance (FID), and cd-FVD (content-debiased Fréchet video distance) were used to evaluate human foreground generation. The metrics FID and cd-FVD were used to evaluate background generation. Face cosine similarity (Face-Cos) was also used to measure face appearance preservation. To compute Face-Cos, the facial regions in both the generated image and the ground-truth image were aligned and cropped. The cosine similarity was then computed between features extracted using AdaFace, frame by frame of the same subject in the test set. The cosine similarity values were then averaged. In addition to the above metrics, the percentage rate of face detection (Face-Det) across all frames was measured.

To evaluate the dynamics detail generation quality, Dynamic Texture Fréchet Video Distance (DTFVD) was used as a quantitative metric. DTFVD was calculated by replacing the pre-trained backbone network in FVD with one trained on Dynamics Texture Database (DTDB) to perform classification. DTFVD was measured for both the whole video frames and the background portions of the video frames after human-background segmentation.

To further test the effectiveness of the video generation model in dynamics detail generation, a user study was also conducted. 50 static reference images were used in this experiment. Users were asked to judge (1) background dynamics quality (BG-Dyn), (2) human foreground dynamics quality (FG-Dyn), and (3) appearance preservation (AP). In the user study, 100 users were asked to rate these three criteria on a scale from 0 to 5.

The video generation model was compared in the above experiments to state-of-the-art diffusion model-based human video animation methods (Models A-D). The following table shows DTFVD results that compare the video generation model with the above methods. In this table, FG-DTFVD denotes the DTFVD on foreground portions of videos after segmentation, and BG-DTFVD denotes DTFVD on background portions. A downward-pointing arrow indicates that lower values are preferred, whereas an upward-pointing arrow indicates that higher values are preferred.

| Method | FG-DTFVD ↓ | BG-DTFVD ↓ | DTFVD ↓ |
|---|---|---|---|
| Model A | 1.753 | 2.142 | 2.601 |
| Model B | 1.789 | 2.034 | 2.310 |
| Model C | 1.846 | 1.901 | 2.412 |
| Model D | 2.639 | 3.274 | 3.590 |
| Video generation model | 0.900 | 1.101 | 1.518 |

As shown in the above table, the video generation model achieves significant improvements over the baseline models in both foreground and background dynamics.

The following two tables present a quantitative analysis of human foreground subjects and background scenes generated with various methods. Segmentation was performed using the Segment Anything model. The first table reports foreground generation performance:

| | | PSNR | LPIPS | SSIM | Face- | Face- | | cd- |
|---|---|---|---|---|---|---|---|---|
| Method | L1 ↓ | ↓ | ↓ | ↑ | Cos ↑ | Det ↑ | FID ↓ | FVD ↓ |
| Model A | 7.42e−05 | 17.143 | 0.228 | 0.739 | 0.297 | 92.1% | 31.97 | 237.59 |
| Model B | 11.8e−05 | 13.411 | 0.338 | 0.605 | 0.402 | 89.0% | 33.75 | 233.39 |
| Model C | 13.7e−05 | 12.639 | 0.345 | 0.618 | 0.396 | 85.5% | 18.52 | 537.96 |
| Model D | 9.78e−05 | 14.903 | 0.278 | 0.647 | 0.193 | 92.0% | 45.67 | 150.01 |
| Video | 7.15e−05 | 17.201 | 0.249 | 0.724 | 0.497 | 94.8% | 22.56 | 325.35 |
| generation | | | | | | | | |
| model | | | | | | | | |

The second table reports background generation performance:

| Method | FID ↓ | cd-FVD ↓ |
|---|---|---|
| Model A | 38.86 | 176.17 |
| Model B | 34.27 | 203.59 |
| Model C | 24.43 | 480.14 |
| Model D | 60.32 | 194.17 |
| Video generation model | 25.59 | 281.78 |

As shown in the above tables, the video generation model achieves competitive performance with the baseline methods.

The results of the user study are shown in the following table:

| Method | FG-Dyn | BG-Dyn | AP | Overall |
|---|---|---|---|---|
| Model A | 2.34 | 2.78 | 3.45 | 2.86 |
| Model B | 2.21 | 2.57 | 3.89 | 2.89 |
| Model C | 2.23 | 2.18 | 3.85 | 2.75 |
| Model D | 2.02 | 2.63 | 2.79 | 2.48 |
| Video generation model | 3.87 | 4.26 | 4.14 | 4.09 |

The “overall” column presents averages across the FG-Dyn, BG-Dyn, and AP scores. The above results demonstrate that the users rate the videos generated with the video generation model as significantly higher quality than those generated with the baseline approaches, across all three of the above scoring criteria.

An ablation study on the video generation model was also performed. The ablation study measured FG-DTFVD, BG-DTFVD, DTFVD, and Face-Cos for variants of the video generation model that (w/RefNet) replace the dynamics adapter with ReferenceNet; (w/IP-A) replace the dynamics adapter with IP-Adapter; (w/lmk) do not use the face control network during fine-tuning and instead use facial feature landmarks along with a pose skeleton; (wo/face) do not use the face control network during fine-tuning; and (wo/fusion) does not use a training dataset that combines human videos and background videos, instead using only human videos. The following table shows the results of the ablation study:

| Method | FG-DTFVD ↓ | BG-DTFVD ↓ | DTFVD ↓ | Face-Cos ↑ |
|---|---|---|---|---|
| w/RefNet | 2.137 | 2.694 | 2.823 | 0.466 |
| w/IP-A | 3.738 | 4.702 | 4.851 | 0.292 |
| w/lmk | 0.914 | 1.125 | 1.589 | 0.406 |
| wo/face | 0.912 | 1.098 | 1.550 | 0.442 |
| wo/fusion | 1.301 | 1.467 | 1.652 | 0.495 |
| Video | 0.900 | 1.101 | 1.518 | 0.497 |
| generation | | | | |
| model | | | | |

The above ablation study results demonstrate that the dynamics adapters, the face control model, and the mixed training dataset all positively contribute to the performance of the video generation model.

The methods and processes described herein are tied to a computing system of one or more computing devices. In particular, such methods and processes can be implemented as a computer-application program or service, an application-programming interface (API), a library, and/or other computer-program product.

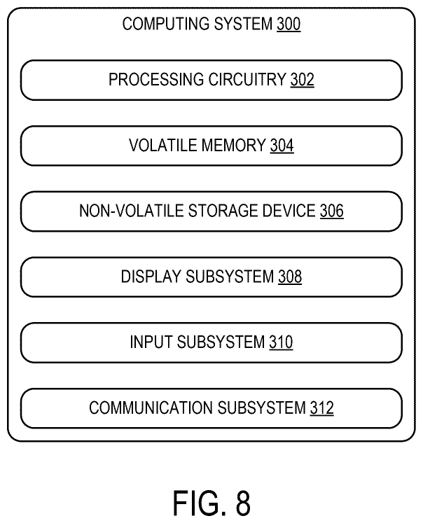

FIG. 8 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 8.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory 304, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. According to one aspect of the present disclosure, a computing system is provided, including one or more processing devices configured to receive a reference image. The one or more processing devices are further configured to receive an input video including a plurality of input video frames. The one or more processing devices are further configured to execute a video generation model to compute an output video based at least in part on the reference image and the input video. The video generation model includes a first denoising diffusion model that includes a plurality of first self-attention layers. The video generation model further includes a plurality of dynamics adapters that are respectively associated with the first self-attention layers and are each configured to, for each of the input video frames of the input video, receive the reference image and the input video frame. For each of the frames of the input video, the dynamics adapters are each further configured to compute a self-attention guidance matrix based at least in part on the reference image and the input video frame. For each of the frames of the input video, the dynamics adapters are each further configured to input the self-attention guidance matrix into the first denoising diffusion model after the first self-attention layer associated with the dynamics adapter. The one or more processing devices are further configured to output the output video for display at a display device. The above features may have the technical effect of generating an output video that includes vivid and consistent background dynamics.

According to this aspect, the first denoising diffusion model may further include a plurality of first cross-attention layers and a plurality of first temporal attention layers. The above features may have the technical effect of increasing the temporal smoothness of the output video.

According to this aspect, the one or more processing devices may be configured to input the self-attention guidance matrix into the first denoising diffusion model by computing a product of a self-attention matrix and a first output projection matrix. The self-attention matrix may be computed at the corresponding first self-attention layer. Inputting the self-attention guidance matrix into the first denoising diffusion model may further include adding the self-attention guidance matrix to the product. The above features may have the technical effect of incorporating the background dynamics guidance computed at the dynamics adapter into the generation of the output video.

According to this aspect, at each of the dynamics adapters, the one or more processing devices may be configured to compute a cross-frame attention matrix based at least in part on the reference image and the input video frame. The one or more processing devices may be further configured to compute the self-attention guidance matrix as a product of the cross-frame attention matrix and a second output projection matrix. The above features may have the technical effect of computing the self-attention guidance matrix that is used to guide the output video generation.

According to this aspect, the reference image may be an image depicting a first user. The input video may be a video depicting a second user. The above features may have the technical effect of generating an output video in which the first user is depicted performing an action performed by the second user in the input video.

According to this aspect, the video generation model may further include a face control model configured to receive a first face patch that is included in the reference image and depicts a first user face of the first user. For each of the input video frames, the face control model may be further configured to compute a user-swapped face patch that maps the first face patch onto a corresponding second face patch that is included in the input video frame and depicts a second user face of the second user. The face control model may be further configured to input the user-swapped face patch into the first denoising diffusion model. The above features may have the technical effect of generating an output video in which the facial expression of the depicted first user matches the facial expression of the second user.

According to this aspect, the face control model may be a second denoising diffusion model that includes a plurality of second self-attention layers and a plurality of second cross-attention layers. The above features may have the technical effect of generating the user-swapped face patch using a denoising diffusion approach.

According to this aspect, the video generation model may further include a pose control model configured to, for each of the input video frames, receive the input video frame. The pose control model may be further configured to compute a respective body pose of the second user in the input video frame. The pose control model may be further configured to input the body pose into the first denoising diffusion model. The above features may have the technical effect of controlling the depicted body pose of the first user in the output video to match that of the second user in the input video.

According to this aspect, the pose control model may be a third denoising diffusion model that includes a plurality of third self-attention layers and a plurality of third cross-attention layers. The above features may have the technical effect of computing the body pose using a denoising diffusion approach.

According to this aspect, the dynamics adapters may be trained using a training dataset including a plurality of training reference images, a plurality of first training input videos that depict humans, and a plurality of second training input videos that depict dynamic backgrounds and do not depict humans. The above features may have the technical effect of training the dynamics adapters to accurately model both human movement and dynamic backgrounds.

According to this aspect, during training of the video generation model, at each of the dynamics adapters, respective parameters of a query matrix and the self-attention guidance matrix included in the dynamics adapter may be modified. Respective parameters of a key matrix and a value matrix included in the dynamics adapter may be held constant. The above features may have the technical effect of specifically training the query matrix and the self-attention guidance matrix.

According to another aspect of the present disclosure, a method for use with a computing system is provided. The method includes receiving a reference image. The method further includes receiving an input video including a plurality of input video frames. The method further includes executing a video generation model to compute an output video based at least in part on the reference image and the input video. The video generation model includes a first denoising diffusion model that includes a plurality of first self-attention layers. The video generation model further includes a plurality of dynamics adapters that are respectively associated with the first self-attention layers and are each configured to, for each of the input video frames of the input video, receive the reference image and the input video frame. The dynamics adapters are each further configured to compute a self-attention guidance matrix based at least in part on the reference image and the input video frame. The dynamics adapters are each further configured to input the self-attention guidance matrix into the first denoising diffusion model after the first self-attention layer associated with the dynamics adapter. The method further includes outputting the output video for display at a display device. The above features may have the technical effect of generating an output video that includes vivid and consistent background dynamics.

According to this aspect, the first denoising diffusion model may further include a plurality of first cross-attention layers and a plurality of first temporal attention layers. The above features may have the technical effect of increasing the temporal smoothness of the output video.

According to this aspect, the method may further include inputting the self-attention guidance matrix into the first denoising diffusion model by computing a product of a self-attention matrix and a first output projection matrix, wherein the self-attention matrix is computed at the corresponding first self-attention layer. Inputting the self-attention guidance matrix into the first denoising diffusion model may further include adding the self-attention guidance matrix to the product. The above features may have the technical effect of incorporating the background dynamics guidance computed at the dynamics adapter into the generation of the output video.

According to this aspect, the reference image may be an image depicting a first user. The input video may be a video depicting a second user. The above features may have the technical effect of generating an output video in which the first user is depicted performing an action performed by the second user in the input video.

According to this aspect, the method may further include, at a face control model included in the video generation model, receiving a first face patch that is included in the reference image and depicts a first user face of the first user. For each of the input video frames, the method may further include computing a user-swapped face patch that maps the first face patch onto a corresponding second face patch that is included in the input video frame and depicts a second user face of the second user. The method may further include inputting the user-swapped face patch into the first denoising diffusion model. The above features may have the technical effect of generating an output video in which the facial expression of the depicted first user matches the facial expression of the second user.

According to this aspect, the method may further include, at a pose control model included in the video generation model, for each of the input video frames, receiving the input video frame. The method may further include, at the pose control model, computing a respective body pose of the second user in the input video frame. The method may further include, at the pose control model, inputting the body pose into the first denoising diffusion model. The above features may have the technical effect of controlling the depicted body pose of the first user in the output video to match that of the second user in the input video.

According to this aspect, the method may further include training the dynamics adapters using a training dataset including a plurality of training reference images, a plurality of first training input videos that depict humans, and a plurality of second training input videos that depict dynamic backgrounds and do not depict humans. The above features may have the technical effect of training the dynamics adapters to accurately model both human movement and dynamic backgrounds.

According to this aspect, during training of the video generation model, training each of the dynamics adapters may include modifying respective parameters of a query matrix and the self-attention guidance matrix included in the dynamics adapter. Training each of the dynamics adapters may further include holding constant respective parameters of a key matrix and a value matrix included in the dynamics adapter. The above features may have the technical effect of specifically training the query matrix and the self-attention guidance matrix.

According to another aspect of the present disclosure, a computing system is provided, including one or more processing devices configured to receive a reference image. The reference image may be an image depicting a first user. The one or more processing devices are further configured to receive an input video including a plurality of input video frames. The input video is a video depicting a second user. The one or more processing devices are further configured to execute a video generation model to compute an output video based at least in part on the reference image and the input video. The video generation model includes a first denoising diffusion model that includes a plurality of first self-attention layers. The video generation model further includes a plurality of dynamics adapters that are each configured to, for each of the input video frames of the input video, receive the reference image and the input video frame. The dynamics adapters are each further configured to compute a self-attention guidance matrix based at least in part on the reference image and the input video frame. The dynamics adapters are each further configured to input the self-attention guidance matrix into the first denoising diffusion model. The video generation model further includes a face control model configured to receive a first face patch that is included in the reference image and depicts a first user face of the first user. For each of the input video frames, the face control model is further configured to compute a user-swapped face patch that maps the face patch onto a corresponding second face patch that is included in the input video frame and depicts a second user face of the second user. The face control model is further configured to input the user-swapped face patch into the first denoising diffusion model. The video generation model further includes a pose control model configured to, for each of the input video frames, receive the input video frame. The pose control model is further configured to compute a respective body pose of the second user in the input video frame. The pose control model is further configured to input the body pose into the first denoising diffusion model. The one or more processing devices are further configured to output the output video for display at a display device. The above features may have the technical effect of generating an output video that includes vivid and consistent background dynamics.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a reference image;
receive an input video including a plurality of input video frames;
execute a video generation model to compute an output video based at least in part on the reference image and the input video, wherein the video generation model includes:
a first denoising diffusion model that includes a plurality of first self-attention layers; and
a plurality of dynamics adapters that are respectively associated with the first self-attention layers and are each configured to, for each of the input video frames of the input video:
receive the reference image and the input video frame;
compute a self-attention guidance matrix based at least in part on the reference image and the input video frame; and
input the self-attention guidance matrix into the first denoising diffusion model after the first self-attention layer associated with the dynamics adapter; and
output the output video for display at a display device.

2. The computing system of claim 1, wherein the first denoising diffusion model further includes a plurality of first cross-attention layers and a plurality of first temporal attention layers.

3. The computing system of claim 2, wherein the one or more processing devices are configured to input the self-attention guidance matrix into the first denoising diffusion model by:
computing a product of a self-attention matrix and a first output projection matrix, wherein the self-attention matrix is computed at the corresponding first self-attention layer; and
adding the self-attention guidance matrix to the product.

4. The computing system of claim 3, wherein, at each of the dynamics adapters, the one or more processing devices are configured to:
compute a cross-frame attention matrix based at least in part on the reference image and the input video frame; and
compute the self-attention guidance matrix as a product of the cross-frame attention matrix and a second output projection matrix.

5. The computing system of claim 1, wherein:
the reference image is an image depicting a first user; and
the input video is a video depicting a second user.

6. The computing system of claim 5, wherein the video generation model further includes a face control model configured to:
receive a first face patch that is included in the reference image and depicts a first user face of the first user; and
for each of the input video frames:
compute a user-swapped face patch that maps the first face patch onto a corresponding second face patch that is included in the input video frame and depicts a second user face of the second user; and
input the user-swapped face patch into the first denoising diffusion model.

7. The computing system of claim 6, wherein the face control model is a second denoising diffusion model that includes a plurality of second self-attention layers and a plurality of second cross-attention layers.

8. The computing system of claim 5, wherein the video generation model further includes a pose control model configured to, for each of the input video frames:
receive the input video frame;
compute a respective body pose of the second user in the input video frame; and
input the body pose into the first denoising diffusion model.

9. The computing system of claim 8, wherein the pose control model is a third denoising diffusion model that includes a plurality of third self-attention layers and a plurality of third cross-attention layers.

10. The computing system of claim 5, wherein the dynamics adapters are trained using a training dataset including:
a plurality of training reference images;
a plurality of first training input videos that depict humans; and
a plurality of second training input videos that depict dynamic backgrounds and do not depict humans.

11. The computing system of claim 1, wherein, during training of the video generation model, at each of the dynamics adapters:
respective parameters of a query matrix and the self-attention guidance matrix included in the dynamics adapter are modified; and
respective parameters of a key matrix and a value matrix included in the dynamics adapter are held constant.

12. A method for use with a computing system, the method comprising:
receiving a reference image;
receiving an input video including a plurality of input video frames;
executing a video generation model to compute an output video based at least in part on the reference image and the input video, wherein the video generation model includes:
a first denoising diffusion model that includes a plurality of first self-attention layers; and
a plurality of dynamics adapters that are respectively associated with the first self-attention layers and are each configured to, for each of the input video frames of the input video:
receive the reference image and the input video frame;
compute a self-attention guidance matrix based at least in part on the reference image and the input video frame; and
input the self-attention guidance matrix into the first denoising diffusion model after the first self-attention layer associated with the dynamics adapter; and
outputting the output video for display at a display device.

13. The method of claim 12, wherein the first denoising diffusion model further includes a plurality of first cross-attention layers and a plurality of first temporal attention layers.

14. The method of claim 13, further comprising inputting the self-attention guidance matrix into the first denoising diffusion model by:
computing a product of a self-attention matrix and a first output projection matrix, wherein the self-attention matrix is computed at the corresponding first self-attention layer; and
adding the self-attention guidance matrix to the product.

15. The method of claim 12, wherein:
the reference image is an image depicting a first user; and
the input video is a video depicting a second user.

16. The method of claim 15, further comprising, at a face control model included in the video generation model:
receiving a first face patch that is included in the reference image and depicts a first user face of the first user; and
for each of the input video frames:
computing a user-swapped face patch that maps the first face patch onto a corresponding second face patch that is included in the input video frame and depicts a second user face of the second user; and
inputting the user-swapped face patch into the first denoising diffusion model.

17. The method of claim 15, further comprising, at a pose control model included in the video generation model, for each of the input video frames:
receiving the input video frame;
computing a respective body pose of the second user in the input video frame; and
inputting the body pose into the first denoising diffusion model.

18. The method of claim 15, further comprising training the dynamics adapters using a training dataset including:
a plurality of training reference images;
a plurality of first training input videos that depict humans; and
a plurality of second training input videos that depict dynamic backgrounds and do not depict humans.

19. The method of claim 12, wherein, during training of the video generation model, training each of the dynamics adapters includes:
modifying respective parameters of a query matrix and the self-attention guidance matrix included in the dynamics adapter; and
holding constant respective parameters of a key matrix and a value matrix included in the dynamics adapter.

20. A computing system comprising:
one or more processing devices configured to:
receive a reference image, wherein the reference image is an image depicting a first user;
receive an input video including a plurality of input video frames, wherein the input video is a video depicting a second user;
execute a video generation model to compute an output video based at least in part on the reference image and the input video, wherein the video generation model includes:
a first denoising diffusion model that includes a plurality of first self-attention layers; and
a plurality of dynamics adapters that are each configured to, for each of the input video frames of the input video:
receive the reference image and the input video frame;
compute a self-attention guidance matrix based at least in part on the reference image and the input video frame; and
input the self-attention guidance matrix into the first denoising diffusion model;
a face control model configured to:
receive a first face patch that is included in the reference image and depicts a first user face of the first user; and
for each of the input video frames:
compute a user-swapped face patch that maps the face patch onto a corresponding second face patch that is included in the input video frame and depicts a second user face of the second user; and
input the user-swapped face patch into the first denoising diffusion model; and
a pose control model configured to, for each of the input video frames:
receive the input video frame;
compute a respective body pose of the second user in the input video frame; and
input the body pose into the first denoising diffusion model; and
output the output video for display at a display device.
